(19) United States
(12) Patent Application Publication
(10) Pub. No.: US 2010/0250432 A1
(43) Pub. Date: Sep. 30, 2010

(54) Systems and methods for bankarizing real estate properties and increasing their yield

(76) Inventor: Riad Obegi, Beirut (LB)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/382,902

(22) Filed: Mar. 26, 2009

(51) Int. Cl. G06Q 40/00; G06F 17/30

(52) U.S. Cl. 705/39; 705/35; 707/E17.014; 707/E17.044

(57) ABSTRACT

Methods and systems for bankarizing real estate properties and increasing their yield. These methods and systems include receiving by a financial institution mortgage certificates, each mortgage certificate representing a first rank mortgage of a real estate property for the benefit of the financial institution. These mortgage certificates can be pledged by the financial institution to get loans. In exchange for the deposit of the mortgage certificates, the owners of the real estate properties get a fee from the financial institution. These methods and systems further include an agency running one or several databases, analyzing relevant information, evaluating the real estate properties object of the mortgage certificates, determining a standard value, issuing the mortgage certificates and producing reports to all parties.

### TECHNICAL FIELD

The present disclosure is related to systems and methods for bankarizing real estate properties and increasing their yield.

### BACKGROUND

The scarcity of credit, essentially but not exclusively in many developing countries, may constitute a hindrance to economic growth. Credit may be scarce based on numerous factors such as the risk that financial institutions (e.g., banks, credit unions, savings and loans, etc.) may not recover certain loans made, or may not be able to borrow additional money.

Besides, major portions of real estate, particularly but not exclusively in developing countries, remain unpledged and/or not invested in projects, instead remaining external to the credit circuit. This real estate wealth may have potential credit value, if it can be used to guarantee loans, which may spur economic growth directly and/or incidentally. However, the financial system may not presently absorb such potential.

One reason for the financial system not integrating the credit value potential of this real estate wealth is that guaranteeing a loan typically may involve both the borrower and the lender to be known to the guarantor as well as the amount of the loan and other features thereof. In addition it would require the lender to have a trustworthy evaluation of the collateral and the guarantor getting a fair remuneration for this guarantee. Otherwise the operation of guarantee could constitute a risk that the guarantor may consider unacceptable.

In the financial systems of many developing countries, as represented in FIG. 1, a financial institution 10 may receive money deposits 12 from clients 14 or financial institutions and, with this money, may finance projects 16. Projects 16 may be personal and/or professional projects, and may include, for example, construction, capital improvements, venture capital, purchase of other real estate, purchase of a company, of inventory, receivables, etc. However, to enable weathering a crisis situation in which a number of clients 14 might simultaneously withdraw the money they have deposited, all the money available to the financial institution 10 cannot be used to finance projects 16. In other words, the financial institution 10 may use a part 18 of its available money, but must keep a reserve 20 of money.

Indeed, as represented in FIG. 2, in the event of such a crisis, the financial institution 10 may not receive prompt reimbursement from the entities receiving financing for projects 16. Further, financial institution 10 may have difficulty obtaining one or more loans 22 from lenders 24. Therefore, depending on the situation, reserve 20 may be used to return deposits to clients 14, among other things.

The amount of reserve 20 may be reduced by an amount approximating the capacity of financial institution 10 to obtain loans. In many countries, at least for small or medium-size financial institutions, it may be difficult to obtain loans, therefore possibly resulting in maintenance of a larger reserve 20.

While reserve 20 may appear on the balance sheet of financial institution 10, it may not contribute substantially to the profit of financial institution 10 since reserve 20 generally may not be used to finance projects 16. Financial institution 10 may, therefore, desire an improvement in its ability to face a crisis and optimizing its profit yield.

An object of the present disclosure is to provide a financial system in which financial institutions may make more profit with the same risk, or make the same profit with a reduced risk.

Another object of the present disclosure is to provide a financial system in which the risk of financial institution bankruptcy is limited.

In addition, the bankruptcy of a financial institution may shake the whole financial sector. Indeed, the loss of confidence of depositors of a financial institution may spread to depositors of other financial institutions and result in a chain of bankruptcies. Therefore, another object of the present disclosure is to improve the stability of the financial system in case of a financial institution bankruptcy.

A crisis of the financial system leads to more severe conditions imposed by the financial institutions to finance projects 16. Therefore, a crisis of the financial system may also result in a crisis of the economic system and have major consequences on the economic development. Therefore, yet another object of the present disclosure is to assist in improving the stability of the economy.

Another object is to provide a standard value of real estate properties thereby increasing the liquidity of the real estate market.

Yet another object is to allow individuals or companies to borrow more easily because of the improved liquidity of the banks.

Importantly, another object of the present disclosure is to allow real estate owners to obtain liquidity and/or better profitability from their asset and possibly more information about the value of said asset.

### SUMMARY OF THE PRESENT DISCLOSURE

The term “mortgage certificate” as used herein, shall mean a certificate bearing a relationship to an underlying real estate property. The mortgage certificate may be pledged in favor of creditors of a financial institution where such mortgage certificate is deposited, up to the amount of a mortgage certificate value and under the conditions specified.

It is important to note that the term “standard value,” as used herein, may not be a “fair market value” of the real estate property. A “fair market value” associated with a real estate property shall mean the value a willing buyer would pay a willing seller for the real estate property in a normal market. The term “standard value” associated with a real estate property shall mean a value related to “fair market value” of the real estate property, but taking into account factors such as those related to a sale in a market other than a normal market (e.g., sale under duress). For example, should a financial institution face bankruptcy, real estate property underlying a mortgage certificate may be liquidated very quickly, which may result in a lower sale price for the real estate property. Further, there may be fees associated with such a sale, e.g., attorney fees, agent fees, etc. These factors, as well as others, may be taken into account when determining the standard value associated with a real estate property.

A mortgage certificate value may be based on the standard value associated with the real estate property, and a mortgage certificate may represent different percentages of a standard value associated with a real estate property. For example, several mortgage certificates may be issued against one real estate property, each certificate representing a percentage of the whole standard value (e.g., five certificates, each representing 20 percent of the standard value).

In some aspects, the present disclosure provides a financial system comprising:
an agency;
a plurality of financial institutions;
a plurality of lenders capable of granting a loan to a financial institution;
a plurality of owners, each owning at least one real estate property and at least one mortgage certificate having a mortgage certificate value related to the standard value of said real estate property,

wherein said mortgage certificate may be deposited by its owner, for the benefit of a financial institution of his choice and against a fee from said financial institution, for a determined period of time during which said mortgage certificate may not be withdrawn by its owner without the agreement of said financial institution (“duration of the deposit”), so that the financial institution may use said mortgage certificate to guarantee one or several loans, for its benefit, from one or several lenders.

Among other purposes, the loans are intended in particular to face a crisis. As will be explained in more detail, the mortgage certificate is not cash flow available to the financial institution and unused to finance projects. However, through guaranteeing said loan(s), it may have the same function as the reserve of the financial institution: since mortgage certificates affected in guarantee allow the financial institution to borrow and thus levy cash, they reduce its need for a reserve so that it may utilize more of its funds to finance projects. The assets of the financial institution may therefore have a better yield and there is more financing for projects, thereby assisting in improving the efficiency of an economy.

### The Owners

A non negligible part of the real estate property in a country is not pledged, so that it is legally available as the underlying asset for mortgage certificates. In addition, real estate properties are sometimes unproductive. Their owners may therefore benefit at a low risk in exploiting them through the deposit of related mortgage certificates. A financial institution may consequently benefit from a great number of mortgage certificates and may be able to provide more easily guarantees to potential loans. The risk of a crisis is therefore reduced.

More generally, since the capacity of the financial institutions to resist a crisis is increased, the financial system and the economy as a whole are more stable.

For the owner of said mortgage certificate, a financial system according to the present disclosure may also be advantageous.

First, the owner of the mortgage certificate may continue to have at his disposal said real estate property even throughout the period of time for which the mortgage certificate will remain available to said financial institution.

Secondly, the owner of a mortgage certificate receives a fee for his depositing said mortgage certificate for the benefit of said financial institution. This fee may depend on the standard value underlying the deposited mortgage certificate and on the duration of the deposit, among other things. Indeed, the longer this duration, the more risky is the depositing of said mortgage certificate for the benefit of said financial institution.

Thirdly, the standard value may be a ceiling price even in situation of crisis, therefore the real estate market has a better liquidity.

Fourthly, owners may more easily borrow from the financial institutions based on deposit of one or more mortgage certificates with the financial institution.

A mortgage certificate has a duration, hereafter “duration of the mortgage certificate”, which is determined at its issuance. This duration is the “life time” of the mortgage certificate, and ends at a date called “the maturity”. At maturity, the owner of the real estate property may ask for the issuance of a new mortgage certificate.

In some embodiments, the owner of said mortgage certificate will remain uninformed of the use made by said financial institution of said mortgage certificate. In particular, the financial institution may conserve its mortgage certificates without allocating them to any loan, the mortgage certificates therefore being unused in the normal situation. On the other hand, in case of need, the financial institution may use the deposited mortgage certificates to guarantee one or several loans from lenders.

The mortgage certificates are not individually allocated to guarantee individualized loans. They may altogether constitute a “mass guarantee” in support of the financial institution's mass indebtedness, or, possibly, they may altogether, or a percentage thereof, guarantee one or several lenders for one or several loans.

In case the financial institution goes bankrupt, said owner has the choice between freeing his mortgage certificate by making a cash deposit of an amount identical to the corresponding mortgage certificate value, or risk the real estate object of said mortgage certificate being liquidated and the proceeds, up to the value of this mortgage certificate, deposited at the financial institution, the corresponding debt of the financial institution towards the owner of the certificate ranking sub passu the debts born further to the bankruptcy. Such amounts would be affected in priority to the lenders having received mortgage certificates in guarantee.

### The Agency

The financial system of the present disclosure also comprises an agency, independent of said financial institutions, said lenders, and said owners, said agency assessing the value of said real estate property and/or effecting a first rank mortgage on the basis of the standard value of said real estate property and/or recording the maturity, according to the agreement between said owner and said financial institution, for said mortgage certificate and/or issuing said mortgage certificate, said first rank mortgage being attached to said mortgage certificate and/or keeping a mortgage certificate database and/or affecting said mortgage certificate to said lender(s).

In some embodiments, the agency may act as an interface, or possibly the sole interface, with said owner for the issuance of said mortgage certificate, and/or with said financial institution and said owner as far as deposition of said mortgage certificate to the benefit of said financial institution is concerned and/or with said financial institution and said lender(s) as far as the guarantee of said loan with said mortgage certificate is concerned.

In some embodiments the agency may help said financial institution secure a loan from lenders.

The agency and/or the lenders and/or the financial institutions and/or the owners communicate through computers and/or manage data associated with mortgage certificates with computer means.

In one aspect, the present disclosure is directed to a method for bankarizing a real estate property owned by an owner. The method may comprise the steps of determining a standard value associated with the real estate property, issuing, by an agency, a mortgage certificate related to the real estate property, and depositing the mortgage certificate in both the account of the owner and of the beneficiary bank.

In another aspect, the present disclosure is related to a method for guaranteeing one or more loans from one or more lenders to a financial institution. The method may include receiving, by the financial institution, mortgage certificates, each mortgage certificate being deposited by an owner of real estate property for the benefit of the financial institution, and having a mortgage certificate value based on the standard value of the real estate property, guaranteeing, by the financial institution, the one or more loans from the one or more lenders with at least a portion of the mortgage certificates, and providing a payment to the owner of the mortgage certificate based on one or more financial parameters.

In yet another aspect, the present disclosure is related to a method for lending money to a financial institution. The method may include requesting, by a lender, a guarantee based on at least a portion of mortgage certificates from said financial institution, the mortgage certificates deposited for the benefit of said financial institution by owners in return for a fee payment by said financial institution, each mortgage certificate being based on a real estate property owned by an owner.

In yet another aspect, the present disclosure may be related to a method for increasing the yield of a real estate property. The method may include mortgaging the real estate property by the owner of the real estate property, depositing a mortgage certificate corresponding to the resulting mortgage for the benefit of a financial institution, and receiving a fee from the financial institution based on the mortgage certificate value and its duration wherein the financial institution may use the mortgage certificate to guarantee a loan, for its benefit, from a lender.

In yet another aspect, the present disclosure may be related to a mortgage certificate owned by an owner and based on a real estate property owned by said owner, such that it may be deposited by said owner for the benefit of a financial institution against the payment of a fee, so that it may be used, for a determined period of time, by said financial institution to guarantee one or several loans to said financial institution by one or several lenders.

In yet another aspect, the present disclosure may be related to a financial system. The financial system may include an agency, a plurality of financial institutions, a plurality of lenders capable of granting a loan to at least one of the plurality of financial institutions, and a plurality of owners, each owning at least one real estate property and at least one mortgage certificate having a value related to the standard value of said real estate property. The mortgage certificate may be deposited by its owner, for the benefit of a financial institution in return for a fee payment from said financial institution, the deposit lasting for a determined period of time during which said mortgage certificate may not be withdrawn by its owner without the agreement of said financial institution, and wherein the financial institution may use said mortgage certificate to guarantee one or more loans, for its benefit, from one or more lenders.

In yet another aspect, the present disclosure may be related to a computer program product, comprising a computer readable medium having computer program code embodied thereon, the computer program code configured to be executed to implement a method for bankarizing real estate properties. The implemented method may include providing a system, wherein the system comprises software modules embodied on a computer readable medium, and wherein the software modules comprise a data interface module, an analysis module, a booking module, and a reporting module. The implemented method may further include receiving, by the data interface module, information associated with a real estate property having an owner, analyzing, by the analysis module, the information to determine a standard value of the real estate property, generating, by the booking module, the mortgage certificate, and storing a record of data related to the real estate properties, the owners, the financial institutions, the lenders, and the transactions related to the mortgage certificates.

The method further includes storage by computer means of large quantities of information related to the real estate properties, the mortgage certificates, the owners, the financial institutions, the lenders, the transactions, and providing information to all parties through secured communication system. It will also generate statements and reporting or statistical information to authorities.

### BRIEF DESCRIPTION OF THE DRAWINGS

The following description, which is given with reference to the appended drawings, further describes the advantages of the present disclosure. In the drawings:

FIGS. 1 and 2 schematically represent the prior art financial system, in a normal situation and in a crisis situation, respectively;

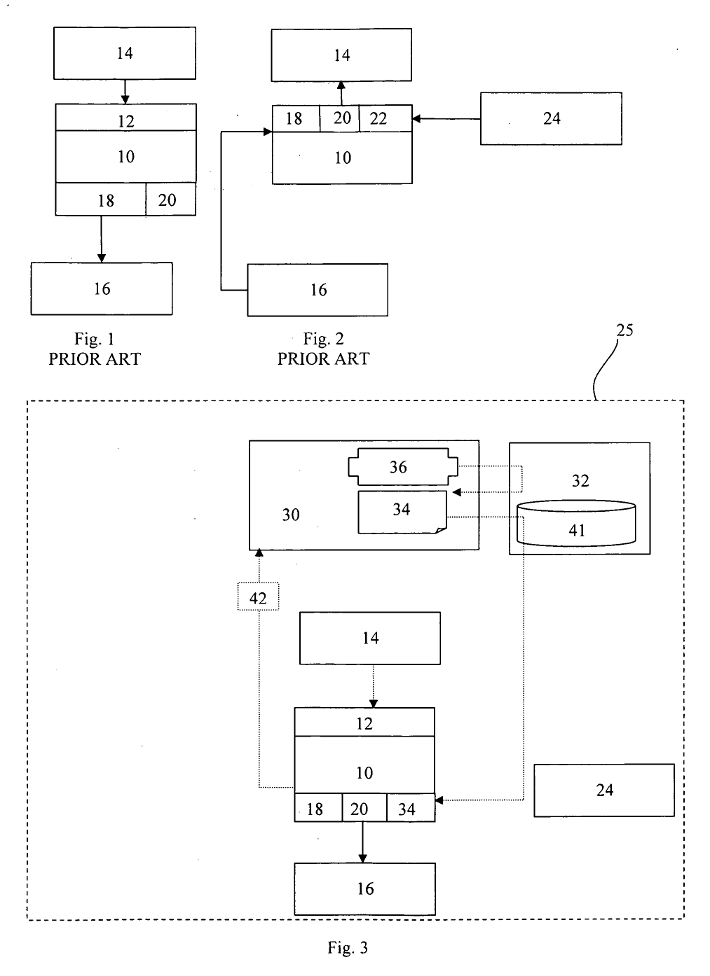

FIGS. 3 and 4 schematically represent an exemplary financial system according to some embodiments of the present disclosure in a normal situation and in a crisis situation, respectively;

FIG. 5 represents an example of a database according to some embodiments of the present disclosure;

FIG. 6 represents an example of a mortgage certificate according to some embodiments of the present disclosure;

FIG. 7 is an exemplary representation of modules for implementing a system consistent with the present disclosure; and

FIGS. 8 and 9 are flowcharts showing an exemplary method for implementing the systems and methods of the present disclosure.

In the different figures, the same references are used to designate similar or identical objects.

### DETAILED DESCRIPTION

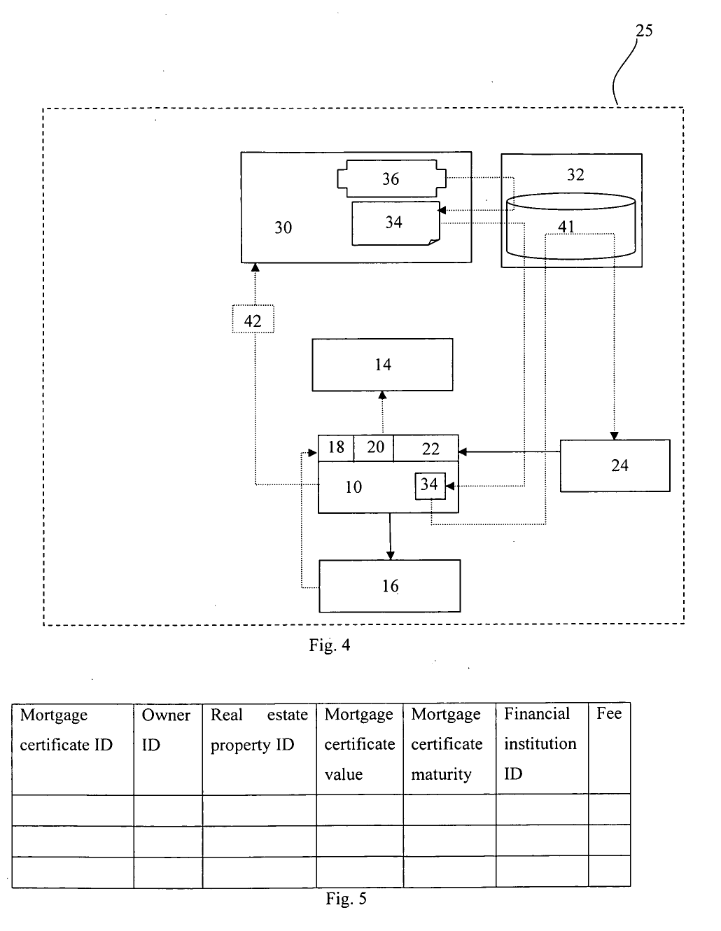

FIG. 3 represents an exemplary financial system 25 according to the present disclosure, in some embodiments. The financial system 25 may comprise a plurality of financial institutions 10, a plurality of owners 30, a plurality of lenders 24, and an agency 32. As used herein, the term financial institutions 10 shall mean any bank, credit union, brokerage, government agency, or other entity involved in the business of borrowing and lending of money and assets, or otherwise dealing with economic and financial issues. The term owner shall mean any owner of real estate property, and the term agency shall mean a third party entity, independent of the financial institutions 10, the owners 30, and the lenders 24.

Each owner 30 may own one or several real estate properties 36 and one or several mortgage certificates 34 based on said real estate properties 36. The owners of mortgage certificates 34 may be companies and/or individuals and/or institutions.

A mortgage certificate 34 is issued by the agency 32 on the request of the owner 30 of a real estate property 36. In some embodiments, the financial system 25 may have only a single agency 32 and no mortgage certificate may be issued outside of agency 32.

To issue a mortgage certificate, agency 32 may determine and certify a value of real estate property 36 (i.e., “the standard value”). This standard value may be less than the fair market value of the real estate property 36, for example, to take into account that the sale of said real estate property 36 may not, upon liquidation, obtain this fair market value. Indeed, any liquidation may result in additional expenses. In addition, such a sale may take place in a crisis environment, with an urgency to sell. Agency 32 may then effect one or several first rank mortgage on the basis of the “standard value” of said real estate property 36 and attach said first rank mortgage to said mortgage certificate 34 as “mortgage certificate value.”

The owner 30 and the financial institution 10 may then agree on a maturity date for the mortgage certificate 34, i.e., the end of its duration during which it has been deposited by its owner 30 for a financial institution 10, and possibly be used by said financial institution 10 to guarantee a loan. In some embodiments, the duration of the mortgage certificate may be less than 2 years. In other embodiments, the duration may be less than 1 year, less than 6 months, or even less than 3 months. For example, depending on various factors, the duration of the mortgage certificate may be 3, 6, 12, or more months.

The owner 30 may deposit the mortgage certificate 34, possibly through the agency 32, for the benefit of a financial institution 10 and in return, receive a fee 42.

This fee 42, e.g., a sum of money for which the owner 30 and the financial institution 10 find an agreement, may depend, for example, on the demand of the financial institutions 10 for mortgage certificates 34, market conditions, standard value, and the duration of the deposit, among others. It is preferably fixed and, paid by the financial institution 10, for example, at maturity, or at the time the mortgage certificate is deposited.

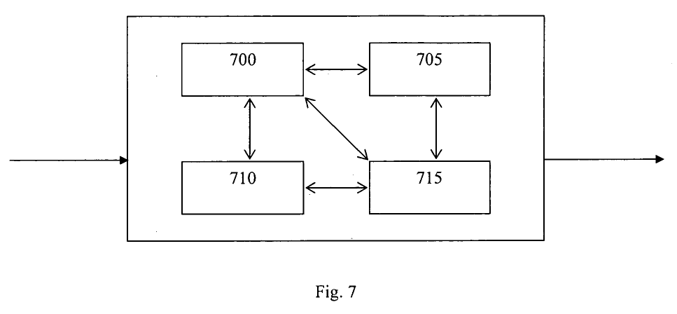

When the owner 30 and the financial institution 10 find an agreement, possibly via the agency 32, the agency is in charge of making this agreement official. In particular, it may issue a paper mortgage certificate, such as the mortgage certificate represented in FIG. 6.

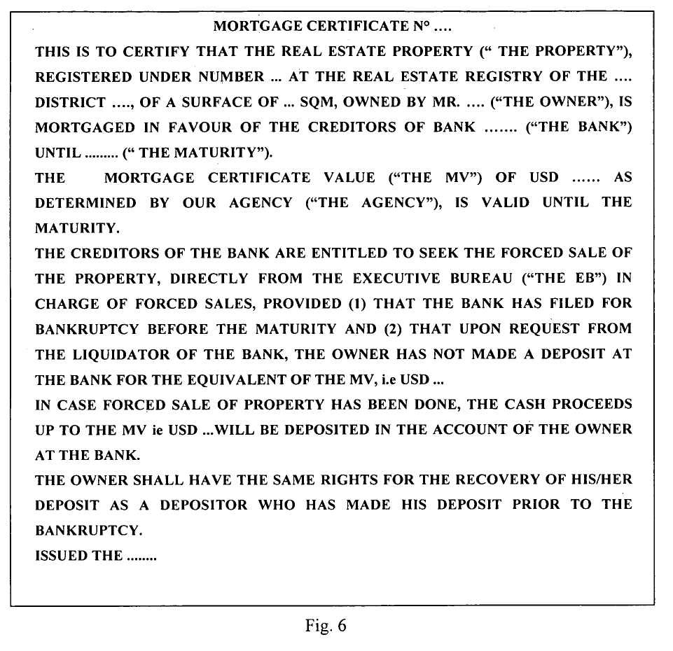

The agency 32 may keep a database 41 with the main information regarding the real estate property 36, the owner 30, the mortgage certificate 34, the mortgage certificate value, the financial institution 10 and the maturity. An exemplary data structure for database 41 is represented in FIG. 5.

In some embodiments, the owner 30 may still use the real estate property 36, while in addition receiving money from the financial institution 10. Many owners 30 may consequently be interested in mortgage certificates 34 based on their real estate property(s) and the financial institution 10 may therefore benefit from the deposit of a great number of mortgage certificates 34.

At the maturity of the deposit, the owner 30 may wish to negotiate with said financial institution or another financial institution 10 for a new deposit. The owner 30 may then request a new mortgage certificate to be issued. In case no agreement has been reached, the property becomes free of any mortgage linked to the mortgage certificate.

In some embodiments, the standard value of the real estate property 36 may be redetermined, by said agency 32, every time a mortgage certificate is issued for said real estate property 36.

For the financial institution 10, mortgage certificates 34 may operate similar to liquidity, thereby resulting in the ability to obtain additional loans. In particular, to be able to manage a crisis when many clients of the financial institution 10 would, in a short period of time, withdraw their money (FIG. 4), the financial institution 10 may keep a limited reserve 20 of money to immediately satisfy the first demands, and have enough mortgage certificates 34 to be able to quickly borrow additional cash to satisfy the following demands. Indeed, its set of mortgage certificates 34 represents a collateral that the financial institution 10 can use to get loans 22 from one or several lenders 24. In some embodiments, the agency 32 may also register the allocation of a portion of the mortgage certificates 34 to a lender 24.

A mortgage certificate may represent a guarantee for a lender 24 because it is based on real estate properties 36. Further, lenders 24 have an extra comfort because the real estate properties 36 have been appraised by the agency 32 at a satisfactory price and, because as there are numerous real estate properties, risk may be diversified.

Consequently, the mortgage certificates 34 make it possible for the financial institution 10 to obtain loan(s), i.e., to get cash flow, very quickly, respond to its clients 14, and face a liquidity crisis.

In the case where financial institution 10 declares bankruptcy, the owner 30 may have a choice between having the real estate property 36 sold and a part of the proceeds equivalent to the value of the mortgage certificate 34 deposited in the financial institution 10 or depositing in the financial institution 10 a sum of money equal to the mortgage certificate value associated with the mortgage certificate 34.

Systems and methods of the present disclosure enable the owners 30 of real estate property 36 to take a limited risk in return for a fee 42, while continuing to use their real estate property 36. In some embodiments, a mortgage certificate 34 can also be used by its owner 30 as a pledge to borrow money from the financial institution 10.

A financial system according to the present disclosure also may be more stable because it may enable financial institutions 10 to have access to more liquidity. Further, it may enable the financial institutions 10 to reduce their reserve of liquidity, and therefore to use their assets more efficiently.

Further there are more loans by financial institutions which ensures more economic growth. Further there is a standard value for almost all real estate assets which facilitates real estate transactions.

### INDUSTRIAL APPLICABILITY

The methods of the present disclosure must be implemented as computer implemented instructions stored on computer readable medium associated with one or more computers. These instructions may be executed by a processor associated with the computer or other similar device for purposes of carrying out the methods of the present disclosure. For example, as described above, one or more computers may be linked via a network or other suitable communication infrastructure for purposes of implementing the methods. In some embodiments, the computer or computers may be located with an agency 32, with the financial institution 10, with a government agency, and/or any other suitable entity or combination thereof.

One or more software modules may be developed for carrying out various tasks associated with the methods described herein. For example, such modules may be developed using object oriented and/or other development techniques, and using Java, C, C++, BASIC, and/or any suitable programming language. One of skill in the art will recognize that many programming languages exist and likely more will be developed in the future. Therefore, the scope of the present disclosure is not intended to be limiting to any one programming language mentioned herein.

Further, each of the modules may be configured for interfacing with one or more databases configured to store, organize, and retrieve data. In some embodiments, such databases may be implemented using Microsoft SQL Server, Oracle, MySQL, flat file systems, or any other suitable data repository. The one or more databases may contain tables consisting of columns and rows, for example, a table similar to that described with regard to the database 41 shown at FIG. 5. Notably, one or more databases may be implemented for purposes of storing data related to the present system and methods.

One of ordinary skill in the art will recognize that various database designs may be implemented for purposes of carrying out the disclosed methods. All such designs are intended to fall within the scope of the present disclosure.

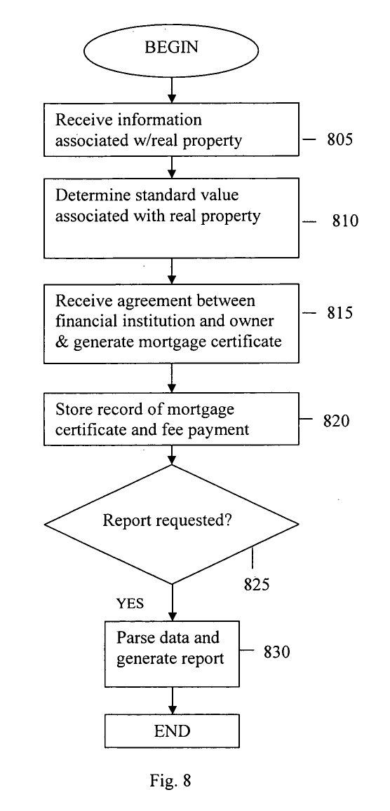

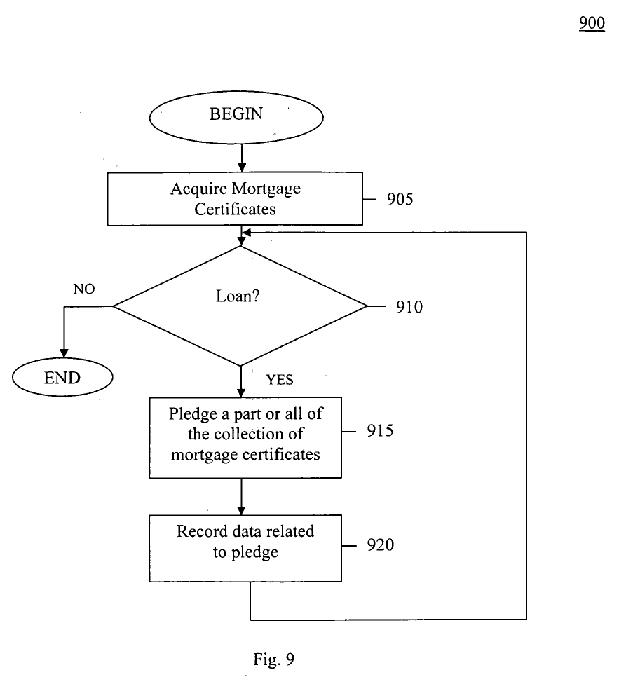

FIG. 7 is an exemplary representation of modules for implementing a system consistent with the present disclosure, while FIG. 8 is a flowchart showing an exemplary method for implementing the systems and methods of the present disclosure. In some embodiments, such modules may include an analysis module 700, a booking module 705, a reporting module 710, and a data interface module 715. Data interface module 715 may be configured to provide one or more interfaces for receiving information from a source. For example, data interface module 715 may include listeners, graphical user interface (GUI) forms and screens, sockets, etc., suitable for receiving information. In such an example, data interface module 715 may be configured to output a GUI form for purposes of manual data entry. Further, a listener and/or socket may enable data interface module to receive information from remotely stationed computers via, for example, a network such as the Internet. Such connections to sockets/listeners may be secured using a variety of data encryption techniques. One of ordinary skill in the art will recognize that the methods of the present disclosure may further be carried out in a distributed computer network environment, and may be enabled over a wide area network. Therefore, security may be implemented as desired using any suitable technique (e.g., Advanced Encryption Standard (AES), Data Encryption Standard (DES), etc.) and security level (e.g., 128-bit, 40-bit, etc.)

In some implementations, the computer may be configured to receive information related to real estate property 36 from, for example, a real estate appraiser, an evaluator, and/or automatically via an interface provided by data interface module 715 (e.g., a socket) (step 805). For example, an appraiser of real estate property 36 may provide a location, a size, a condition, and/or various other attributes related to a real estate property 36 for purposes of appraising the real estate property 36. The real estate appraiser may be provided the GUI form via data interface module 715 and a display for purposes of inputting such data, or, alternatively, the real estate appraiser may provide such information to a trained user such that the trained user may enter the information into the computer. Data interface module 715 may also be capable of communicating with other modules, such as analysis module 700, booking module 705, reporting module 710, and/or a dedicated GUI module, for providing various other interfaces to a display associated with the one or more computers, for example, a results interface, for example.

Analysis module 700 may integrate various parameters, for example, location, size, condition, property status, usage and/or various other attributes from multiple sources such as the land registrar, real estate appraisers and even foreign sources. It may further determine a standard value for each piece of real estate property (step 810).

Booking module 705 may generate one or more mortgage certificates (step 815) and may record information related to the real estate pieces included in the program and (e.g., in the database) (step 820). Booking module 705 may, therefore, receive information (step 805) from analysis module 700, data interface module 715, a land registrar, and the financial institutions, as well as maintaining a history of deposits and/or of pledge transactions.

Because the information related to the mortgage certificates 34 is stored in the database, reporting module 705 and/or booking module 710 may be configured to parse data and produce various reports for financial institutions 10 e.g., mortgage certificates 34 deposited for their benefit, real estate trends, etc. (step 830). For example, a report may be requested (step 825: yes) and generated from the data showing the financial position and mortgage certificate deposits of a particular financial institution. One of ordinary skill in the art will recognize that various other such reports are possible and intended to fall within the scope of the present disclosure. It may also deliver information to the relevant authorities, the owners concerning their properties, the financial institutions for all pieces of real estate, and the lenders 24 concerning their collaterals. It may also generate statements related to the same. Such information may be made available via a network, such as, for example, the Internet.

FIG. 9 is a flowchart 900 showing one exemplary method for securing a loan by a financial institution. As noted above, mortgage certificates may be deposited for the benefit of a financial institution 10 (step 905). In some embodiments, following acquisition of mortgage certificates, a financial institution may request a loan from a lender (step 910: yes). Upon requesting such a loan, the financial institution may utilize a portion or all of the whole of the acquired mortgage certificates 34, which were deposited for its benefit, to guarantee a loan from the lender 24 (step 915). For example, financial institution 10 may experience a particularly high demand for cash from its depositors (e.g., during an economic downturn). Financial institution 10 may have insufficient cash to pay out such depositors. Therefore, financial institution 10 may request one or more loans of cash from one or more lenders 24 for purposes of covering a cash demand. Because financial institution 10 may have mortgage certificates 34 deposited for its benefit, financial institution 10 may utilize such certificates 34 for guaranteeing the one or more loans with the one or more lenders 24. In such an example, and upon such a guarantee, records in the database associated with such certificates 34 may be marked and/or assigned to indicate their status as, for example, “pledged” (step 920). In some embodiments, partial assignments of mortgage certificates 34 may be permitted and may be noted accordingly in the database.

In some embodiments, one mortgage certificate will be issued for a specific real estate property and for a value not exceeding the standard value. Alternatively several mortgage certificates 34 may be issued for a specific real estate property for a total value not exceeding the standard value.

In such an example, a standard value determined to be $400,000, may have four mortgage certificates 34 issued at a face value of $100,000 per mortgage certificate. Each of these four certificates may be deposited for the benefit of different banks, or the same bank, as desired by the owner.

In some embodiments, the fee 42 paid by a financial institution to the benefit of a mortgage certificate 34 owner may be paid recurrently or once for all. Preferably, the duration of the deposit is short and the fee 42 is paid once for all, for example, at the deposition of the mortgage certificate 34, or at maturity.

In some embodiments, a reference of the mortgage certificate 34, the identification of its owner 30, its value, and the reference of the real estate property 36 and its standard value are entered into database 41. The database 41 may also comprise, when the mortgage certificate 34 has been attributed to a financial institution, the identification of this financial institution. The maturity of the mortgage certificate and/or the duration of the deposit and/or the fee 42 for benefitting of the mortgage certificate may also be entered into database 41.

Information about mortgage certificates 34 may also be registered into and/or extracted from a governmental agency regulating such activities. For example, the cadastre in France, or the property records of the local courthouse of a jurisdiction in the United States.

It will be apparent to those skilled in the art that various modifications and variations can be made to the disclosed systems and methods for bankarizing real estate property and increasing its yield. Other embodiments will be apparent to those skilled in the art from consideration of the specification and practice of the disclosed systems and methods for bankarizing real estate property and increasing its yield. It is intended that the specification and examples be considered as exemplary only, with a true scope being indicated by the following claims and their equivalents.

What is claimed is:

1. A method for bankarizing a real estate property owned by an owner, the method comprising:
determining a standard value associated with the real estate property;
issuing, by an agency, a mortgage certificate based on said standard value;
depositing the mortgage certificate for the benefit a financial institution; and
paying a fee to the owner by said financial institution.

2. A method for guaranteeing one or more loans from one or more lenders to a financial institution, the method comprising:
receiving, by the financial institution, mortgage certificates, each mortgage certificate being deposited by an owner of real estate property for the benefit of the financial institution, and having a mortgage certificate value based on a standard value of the real estate property;
guaranteeing, by the financial institution, the one or more loans from the one or more lenders with at least a portion of the mortgage certificates; and
providing a payment to the owner of the mortgage certificate based on one or more financial parameters.

3. The method of claim 2, wherein the one or more financial parameters includes at least one of the mortgage certificate value, a market condition, and a deposit duration.

4. The method according to claim 2, in which the mortgage certificates comprise all mortgage certificates deposited for the benefit of said financial institution.

5. The method according to claim 2, in which each mortgage certificate is deposited for a determined period of time, during which each mortgage certificate may not be withdrawn by the owner without the agreement of said financial institution, and wherein the determined period of time is negotiated between the owner of each of said mortgage certificates and said financial institution.

6. The method according to claim 2, in which the owner includes at least one of an individual, a company, and an institution.

7. The method according to claim 2, wherein bankruptcy of the financial institution results in the owner having the choice between freeing their mortgage certificate in return for a cash deposit of an amount identical to the mortgage certificate value, or risk the real estate property associated with the mortgage certificate being liquidated.

8. The method according to claim 2, in which the mortgage certificate is issued by a single agency, the single agency being independent of said financial institution, said one or more lenders, and said owner.

9. A method for lending money to a financial institution, comprising:
requesting, by a lender, a guarantee based on at least a portion of mortgage certificates from said financial institution, the mortgage certificates deposited for the benefit of said financial institution by owners in return for a fee payment by said financial institution, each mortgage certificate being based on a real estate property owned by an owner.

10. A method for increasing the yield of a real estate property, comprising:
mortgaging the real estate property by the owner of the real estate property;
depositing a mortgage certificate corresponding to the resulting mortgage for the benefit of a financial institution;
receiving a fee from the financial institution based on the mortgage certificate value and its duration wherein the financial institution may use the mortgage certificate to guarantee a loan, for its benefit, from a lender.

11. A mortgage certificate owned by an owner and based on a real estate property owned by said owner, such that it may be deposited by said owner for the benefit of a financial institution against the payment of a fee, so that it may be used, for a determined period of time, by said financial institution to guarantee one or several loans to said financial institution by one or several lenders.

12. A computer database comprising identifications of mortgage certificates according to claim 11, identifications of owners of the mortgage certificates, identifications of real estate properties on which the mortgage certificates are based, values of the mortgage certificates, standard values of the real estate properties, identifications of the financial institutions, maturity dates, and a history of transactions stored in the database.

13. A computer database according to claim 12, including the identity of the lenders, a history of transactions, and an identification of the loans guaranteed by said mortgage certificates.

14. A computer database according to claim 13, further comprising a history of the standard values associated with the real estate property.

15. A financial system comprising:
a plurality of financial institutions;
a plurality of lenders capable of granting a loan to at least one of the plurality of financial institutions; and
a plurality of owners, each owning at least one real estate property and at least one mortgage certificate having a value related to the standard value of said real estate property,
wherein said mortgage certificate may be deposited by its owner, for the benefit of a financial institution in return for a fee payment from said financial institution, the deposit lasting for a determined period of time during which said mortgage certificate may not be withdrawn by its owner without the agreement of said financial institution, and wherein the financial institution may use said mortgage certificate to guarantee one or more loans, for its benefit, from one or more lenders.

16. A financial system according to claim 15, further comprising an agency, independent of said plurality of financial institutions, said plurality of lenders, and said plurality of owners, said agency performing at least one of assessing the value of said real estate property, determining a standard value, effecting a first rank mortgage on the basis of the standard value of said real estate property, keeping a mortgage certificate database, issuing said mortgage certificate, said first rank mortgage being attached to said mortgage certificate, and providing a pledge based on the mortgage certificates to said lenders.

17. A financial system according to claim 16, in which the agency acts as an interface with the owner, with the financial institution, and with the lender.

18. A financial system according to claim 17, further comprising a secure network of computers linking the agency, the plurality of lenders, the plurality of financial institutions, and the plurality of owners, so that at least one of the plurality of lenders, the plurality of financial institutions, and the plurality of owners may perform at least one of consulting a mortgage certificate database managed by said agency, giving instructions to the agency for depositing mortgage certificates for the benefit of a financial institution, and giving instructions to the agency for issuing a guarantee in favor of the one or more lenders.

19. A computer program product, comprising a computer readable medium having computer program code embodied thereon, the computer program code configured to be executed to implement a method for bankarizing real estate properties, the method comprising:
providing a system, wherein the system comprises software modules embodied on a computer readable medium, and wherein the software modules comprise, a data interface module, an analysis module, a booking module, and a reporting module;
receiving, by the data interface module, information associated with a real estate property having an owner;
analyzing, by the analysis module, the information to determine a standard value of the real estate property;
generating, by the booking module, the mortgage certificate; and
storing a record of data related to the real estate property, the owner, a financial institution, a lender, and a transaction related to the mortgage certificate.

20. The computer program product of claim 19, wherein the implemented method further comprises generating, by the reporting module, a report related to the record, wherein the report is accessible via a network.

21. The computer program product of claim 20, wherein the implemented method further comprises, assigning a portion or the whole of all the mortgage certificates recorded in the database in favor of a financial institution, to guarantee one or more loans to said financial institution.

22. The computer program product of claim 21, wherein the implemented method further comprises:
parsing, by at least one of the booking module and the reporting module, a plurality of records in the database to prepare a report summarizing a financial status of a financial institution for purposes of guaranteeing one or more loans to the financial institution.

23. The computer program product of claim 19, wherein the information associated with the real estate property includes a location, a condition, and a description of the real estate property.

24. The computer program product of claim 23, wherein the analyzing step includes a determination of standard value based on the location, character, description of the real estate property, and a comparison with other real estate properties.
